(19) United States
(12) Patent Application Publication
(10) Pub. No.: US 2017/0277723 A1
(43) Pub. Date: Sep. 28, 2017

(54) DATA MANAGEMENT DEVICE, DATA MANAGEMENT METHOD, AND COMPUTER PROGRAM PRODUCT

(71) Applicant: Kabushiki Kaisha Toshiba, Minato-ku (JP)

(72) Inventors: Hidekazu TADOKORO, Fuchu (JP); Hidenori MATSUZAKI, Fuchu (JP); Masahiro ISHIYAMA, Kawasaki (JP)

(73) Assignee: Kabushiki Kaisha Toshiba, Minato-ku (JP)

(21) Appl. No.: 15/380,417

(22) Filed: Dec. 15, 2016

(30) Foreign Application Priority Data
Mar. 22, 2016 (JP) 2016-057003

(51) Int. Cl. G06F 17/30; G06F 3/06

(52) U.S. Cl. CPC G06F 17/30283; G06F 17/30356; G06F 17/30371; G06F 3/0613; G06F 3/0659; G06F 3/067

(57) ABSTRACT

An obtaining unit obtains a first-type request which includes address information corresponding to a writing instruction or a reading instruction with respect to a value. A converting unit converts the first-type request into a second-type request which includes a key having a combination of the address information and version information. The version information is updated every time the writing instruction is issued with the position indicated by the address information as the writing position. Based on the second-type request, a control unit either performs a writing operation for writing the value corresponding to the key in a key value store type database including a plurality of storage devices each of which is set either as a master storage device or as a slave storage device, or performs a reading operation for reading the value corresponding to the key from the database.

### CROSS-REFERENCE TO RELATED APPLICATIONS

This application is based upon and claims the benefit of priority from Japanese Patent Application No. 2016-057003, filed on Mar. 22, 2016; the entire contents of which are incorporated herein by reference.

### FIELD

Embodiments described herein relate generally to a data management device, a data management method, and a computer program product.

### BACKGROUND

As a data management method used in assembling a database, the key value store (KVS) method is known. In the KVS method, data made of pairs of keys, which represent identification information, and values, which are the targets for writing and reading, is stored in a storage device. The user can specify a key, and can write or read the desired value at high speeds.

If the KVS-type data is replicated among a plurality of storage devices, it becomes possible to build a storage system having redundancy and a high degree of reliability. Usually, the operations for such replication are performed not in the client server representing the user interface but in the storage system. For example, there is a method in which a storage server copies a snapshot of the data, which is stored in a host storage device, into slave storage devices.

In a KVS-type database assembled across a plurality of storage devices, the order of writing needs to be managed in order to guarantee consistency in the operations among the storage devices. Simply, if the number of writing operations that can be performed at a single timing is limited to one, it becomes possible to guarantee consistency. However, according to this method, operations such as writing cannot be processed using a pipeline thereby leading to decline in the throughput.

### BRIEF DESCRIPTION OF THE DRAWINGS

FIG. 1 is a diagram illustrating a basic functional configuration of a data management system according to a first embodiment;

FIG. 2 is a diagram illustrating a hardware configuration of the data management system according to the first embodiment;

FIG. 3 is a diagram illustrating a specific functional configuration of the data management system according to the first embodiment;

FIG. 4 is a diagram illustrating the state in the case in which a writing instruction is issued in the data management system according to the first embodiment;

FIG. 5 is a diagram illustrating the state in the case in which a writing instruction is implemented in the data management system according to the first embodiment;

FIG. 6 is a diagram illustrating the state in the case in which a reading instruction is issued in the data management system according to the first embodiment;

FIG. 7 is a diagram illustrating the state in the case in which a reading instruction is implemented in the data management system according to the first embodiment;

FIG. 8 is a diagram illustrating the state in the case in which a writing instruction and a reading instruction are issued in the data management system according to the first embodiment;

FIG. 9 is a diagram illustrating the state in the case in which a failure occurs in the master storage device of the data management system according to the first embodiment;

FIG. 10 is a diagram illustrating the state in the case in which key value store (KVS) requests are retransmitted in the data management system according to the first embodiment;

FIG. 11 is a diagram illustrating the state in the case in which the instructions corresponding to the retransmitted KVS requests are implemented in the data management system according to the first embodiment;

FIG. 12 is a diagram illustrating a functional configuration of a data management system according to a second embodiment; and

FIG. 13 is a diagram illustrating the state in the case in which the data corresponding to the past sets of version information is deleted in the data management system according to the second embodiment.

### DETAILED DESCRIPTION

### First Embodiment

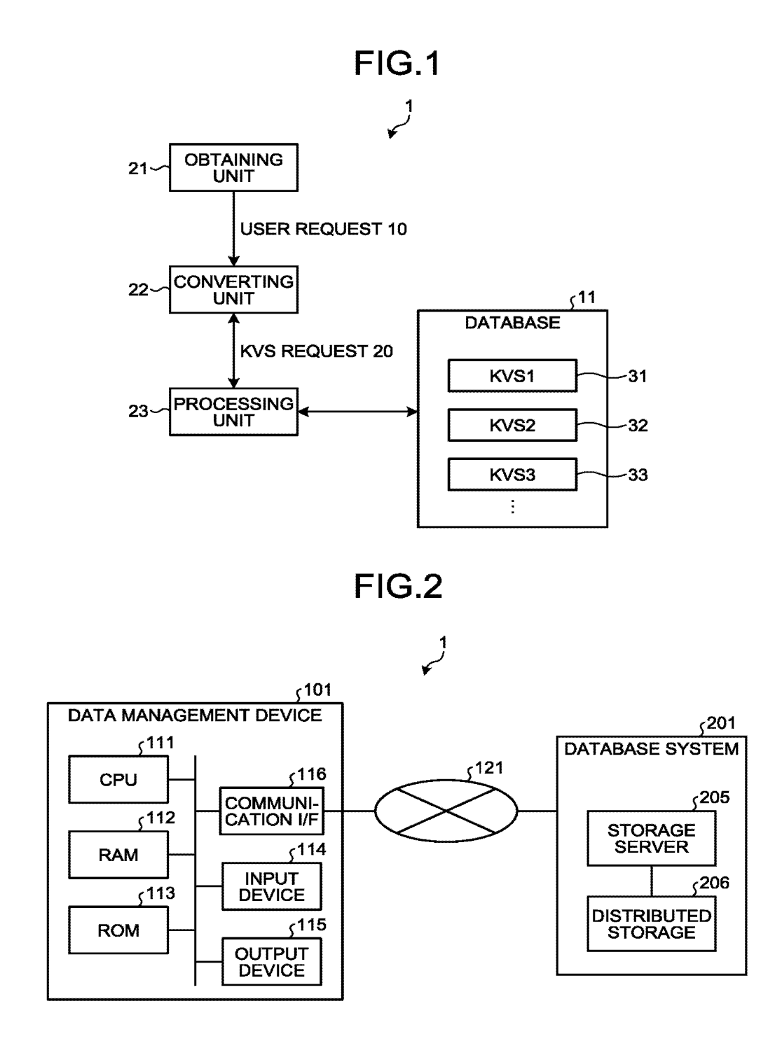

FIG. 1 is a diagram illustrating a basic functional configuration of a data management system 1 according to a first embodiment. The data management system 1 includes a database 11, an obtaining unit 21, a converting unit 22, and a control unit 23.

The database 11 is a KVS-type distributed database including a plurality of KVS-type databases 31 to 33. Each of the KVS-type databases 31 to 33 is used to store data made of pairs of keys, which represent identification information, and values, which are the targets for writing and reading.

The obtaining unit 21 obtains a user request 10 (a first-type request) as an instruction for writing a value in the database 11 or reading a value from the database 11. The user request 10 includes address information corresponding to a writing operation or a reading operation. The address information can be, for example, information enabling identification of sectors assigned according to the logical block addressing (LBA). However, the address information is not limited to the LBA-based information, and alternatively can be a KVS key, for example.

The converting unit 22 converts the user request 10 into a KVS request 20 (a second-type request). The KVS request 20 can be a KVS command including a key. In the first embodiment, the key included in the KVS request 20 includes a combination of address information and version information. Herein, for each set of address information, the version information is assigned and is updated every time a writing instruction is issued in which the corresponding address information represents the writing position. For example, in the case in which version information “0” is assigned for the initial writing instruction in which address information “0” represents the writing position, when the second writing instruction is issued in which the address information “0” represents the writing position, the version information is updated to “1” (this manner of updating is only exemplary). That is, the converting unit 22 generates information containing a combination of the address information, which is included in the user request 10, and the version information, which is updated every time a writing instruction is issued; and generates a key to be used in searching the KVS-type database 11.

Based on the KITS request 20 generated by the converting unit 22, the control unit 23 either performs a writing operation for writing a value in the database 11 or performs a reading operation for reading a value from the database 11. As a result of a writing operation performed by the control unit 23, such data is written in the database 11 which contains key value pairs that are segmented by keys including version information. Since the version information is updated every time a writing instruction is issued, it results in maintaining consistency in the order of writing.

FIG. 2 is a diagram illustrating a hardware configuration of the data management system 1 according to the first embodiment. The data management system 1 according to the first embodiment includes a data management device 101 and a database system 201. The data management device 101 is an information processing device constituting a user interface, and is sometimes called a client server. The data management device 101 includes circuitry such as a central processing unit (CPU) 111, a random access memory (RAM) 112, a read only memory (ROM) 113, an input device 114, an output device 115, and a communication interface (I/F) 116.

The CPU 111 follows a control program stored in the ROM 113, and performs predetermined arithmetic processing using the RAM 112 as the working area. The input device 114 is a device used to input information from outside. Examples of the input device 114 include a keyboard, a mouse, and a touch-sensitive panel. The output device 115 is a device used to output internally-generated information to outside. Examples of the output device 115 include a display and a speaker. The communication I/F 116 is a device that enables transmission of information to and reception of information from external devices via a network 121. Using the data management device 101, at least some of the functions of the obtaining unit 21, the converting unit 22, and the control unit 23 are implemented. The obtaining unit 21, the converting unit 22, and the control unit 23 can be configured using the CPU 111 that performs operations according to computer programs; or can be configured using various logic circuits; or can be configured using cooperation between the CPU 111 and various logic circuits.

The database system 201 includes a storage server (a file server) 205 and distributed storage 206. In an identical manner to the data management device 101, the storage server 211 is an information processing device that includes a CPU controlled by computer programs, a ROM used to store computer programs, and a RAM serving as the working area. The distributed storage 212 includes a plurality of storage devices in each of which a KVS-type database is assembled. A storage device can be a flash memory device (such as a solid state device (SSD)) or can be a magnetic memory device (such as a hard disk drive (HDD)). Based on the KVS protocol, the storage server 211 performs an operation for writing a value in the distributed storage 212, an operation for reading a value from the distributed storage 212, an operation for setting a master storage device, and an operation for setting slave storage devices. Using the database system 201, the functions of the database 11 are implemented.

Meanwhile, the hardware configuration illustrated in FIG. 2 is only exemplary, and the embodiments are not limited to have that hardware configuration. For example, a plurality of data management devices 101 can be connected to a single database system 201. Alternatively, a plurality of database systems 201 can be connected to a single data management device 101. Still alternatively, a plurality of storage servers 211 can be installed in a corresponding manner to a plurality of storage devices. Meanwhile, the data management device 101 and the database system 201 can be configured using a single information processing device. In that case, the distributed storage 212 is built using the storage devices inside the information processing device, and the functions of the storage server 211 are implemented by the CPU 111. Regarding the hardware configuration of the data management system 1, it is possible to suitably use a known technology or a new technology, and the design should be done freely within the range in which the functions of the functional blocks illustrated in FIG. 1 can be implemented.

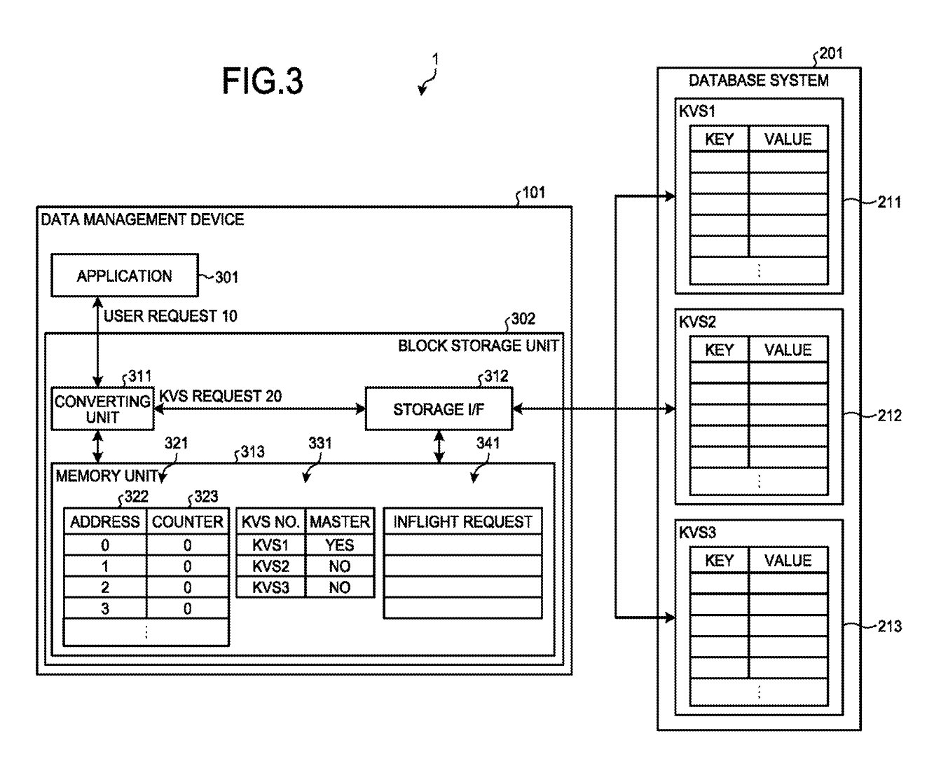

FIG. 3 is a diagram illustrating a specific functional configuration of the data management system 1 according to the first embodiment. The data management system 1 illustrated in this example corresponds to the hardware configuration illustrated in FIG. 2, and includes the data management device 101 and the database system 201.

The data management device 101 includes an application 301 and a block storage unit 302.

The application 301 corresponds to at least some portion of the obtaining unit 21 illustrated in FIG. 1. The application 301 has a user interface function, and receives user operations and outputs a variety of data. It is the application 301 via which the user can issue instructions for writing and reading values. For example, as a writing instruction, the user can input the value to be written and the address information indicating the writing position (the storage location). As a reading instruction, the user can input the address information indicating the writing position of the value to be read.

The application 301 obtains (generates) the user request 10 based on the user input. In this example, the user request 10 can also include instruction-details information, address information, and a value. The instruction-details information enables identification of the type of the instruction desired by the user; and can be a character string, a symbol, or a value assigned to each type of instruction such as “writing” or “reading”. The address information enables identification of the writing position or the reading position as described earlier, and can be a value assigned according to the LBA method or can be a key in the KVS method. The value represents the target data for writing, and can be a text file or an image file. Depending on the type of instruction (for example, in a reading instruction), the value may not be included in the user request 10.

The block storage unit 302 performs, based on the user request 10, an operation for writing a value in the database system 201 or an operation for reading a value from the database system 201. For example, the block storage unit 302 implements the LBA method and performs various operations in such a way that as if writing/reading of a value is being performed with respect to a single memory area. The block storage unit 302 includes a converting unit 311, a storage I/F 312, and a memory unit 313.

The converting unit 311 corresponds at least to some portion of the converting unit 22 illustrated in FIG. 1. The converting unit 311 converts the user request 10, which is obtained from the application 301, into the KVS request 20. Herein, the KVS request 20 is an instruction for operating the database system 201, and can be a KVS command, for example. A KVS command is decided according to the software installed in the storage server 211 of the database system 201. For example, a KVS command can include a “SET” command representing writing and a “GET” command representing reading. A SET command includes a pair of a key and a value. A GET command includes a key, but may not include a value. Meanwhile, although a number of other types of KVS commands are also known, the explanation thereof is not given herein. However, it does not imply that the use of commands other than SET and GET is restricted in the first embodiment.

As described earlier, the converting unit 311 combines address information and version information included in the user request 10, and generates a key to be included in a KVS command. Herein, the converting unit 311 manages a counter table 321 stored in the memory unit 313, and sets the version information corresponding to the address information based on the counter table 321.

The counter table 321 indicates the correspondence relationship between address information and a counter value 323. Herein, the counter value 323 is assigned to each set of address information 322. Every time a writing instruction (the user request 10) is issued in which the position indicated by the address information 322 is the writing position, the converting unit 311 increments the counter value 323 corresponding to that address information 322.

The storage I/F 312 corresponds to at least some portion of the control unit 23 illustrated in FIG. 1. The storage I/F 312 controls the transmission and reception of data between the data management device 101 and the database system 201. The storage I/F 312 transmits the KVS request, which is generated by the converting unit 311, to the database system 201; and receives data (such as a value or a response signal) obtained from the database system 201.

The storage I/F 312 manages a master monitoring table 331 and a request monitoring table 341 that are stored in the memory unit 313.

The master monitoring table 331 indicates whether each of a plurality of (for example, three) storage devices 211 to 213 included in the database system 201 is a master storage device or a slave storage device. The master monitoring table 331 illustrated in FIG. 3 indicates that the first storage device 211 (KVS1) is the master storage device, and that the second storage device 212 (KVS2) and the third storage device 213 (KVS3) are slave storage devices. The switching between a master storage device and a slave storage device either can be performed only according to the operations in the database system 201 or can be performed in response to an instruction from the data management device 101. The storage I/F 312 updates the master monitoring table 331 in response to a change in the master storage device.

The storage I/F 312 transmits the KVS request 20 for a writing operation (for example, the KVS request 20 including the SET command) to the master storage device and the slave storage devices; but transmits the KVS request 20 for a reading operation (for example, the KVS request 20 including the GET command) only to the master storage device. A normal reading operation is performed using only the master storage device, and a writing operation is performed with respect to the master storage device as well as the slave storage devices so as to achieve redundancy. As a result, redundancy can be achieved without having to perform the operation of copying the snapshot of the host in the slave storage devices in the database system 201.

The request monitoring table 341 is a table in which such KVS requests 20 are listed which have been issued for instructing a writing operation but which are determined to be unimplemented. In this example, firstly, the storage I/F 312 adds, in the request monitoring table 341, the KVS request 20 that has been issued by the storage I/F 312 to the master storage device of the database system 201. Thereafter, when a response indicating that the writing is performed normally is received from the master storage device, the storage I/F 312 deletes the concerned KVS request 20 from the request monitoring table 341. Thus, the KVS requests 20 that remain listed in e request monitoring table 341 are such KVS requests 20 in response to which the implementation of the requested operation is not confirmed.

Regarding the KVS requests 20 listed in the request monitoring table 341, the storage I/F 312 retransmits those KVS requests based on a predetermined condition. Examples of the predetermined condition include the case in which there is a change in the master storage device and the case in which identical KVS requests 20 are listed in the request monitoring table 341 for a predetermined period of time or beyond. The version information included in the retransmitted KVS requests 20 matches with the version information that was included in the key of the identical KVS request transmitted earlier. As a result, the KVS requests 20 that are retransmitted are prevented from being treated as new KVS requests 20, thereby making it possible to maintain consistency in the writing operations.

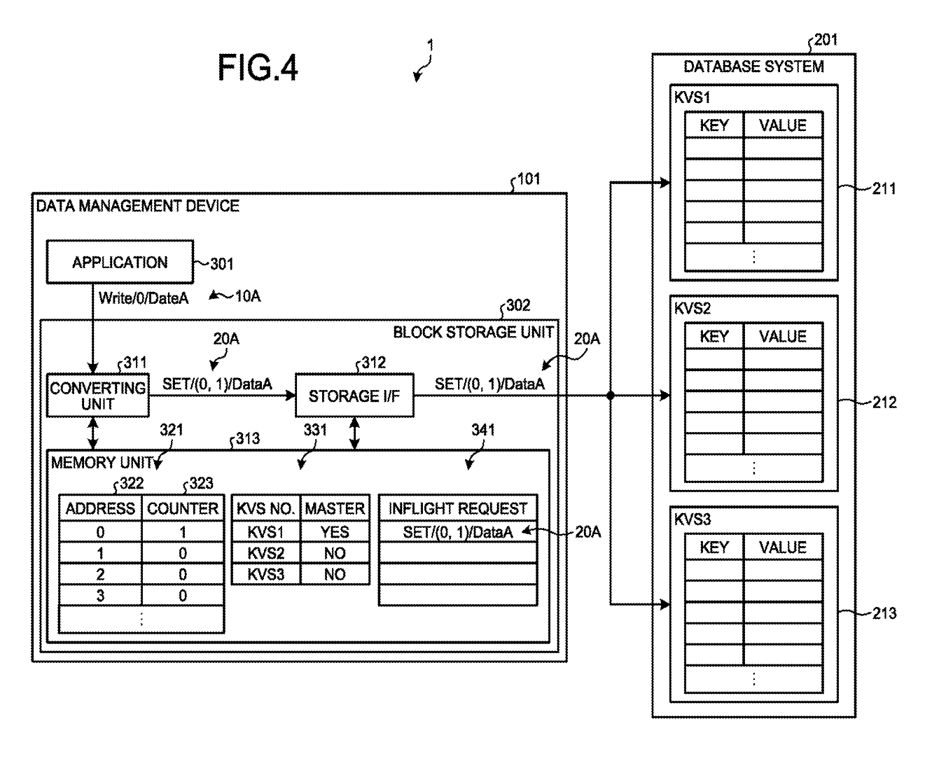

Explained below with reference to FIGS. 4 to 11 is an exemplary sequence of operations performed in the data management system 1. FIG. 4 is a diagram illustrating the state in the case in which a writing instruction is issued in the data management system 1 according to the first embodiment. In this example, it is illustrated that the application 301 receives from the user an instruction for writing target data (value) “DataA” in the area indicated by the address information “0”. Then, the application 301 generates a user request 10A including a character string “Write” that indicates the writing instruction; the address information “0”; and the value “DataA”.

The converting unit 311 converts the user request 10A into a KVS request 20A. Herein, the KVS request 20A includes the command “SET” indicating a writing instruction; a key “(0, 1)”; and the value “DataA”.

Firstly, the converting unit 311 updates the counter table 321 in a corresponding manner to the fact that “Write” is included in the user request 10A. Moreover, the converting unit 311 increments the counter value 323, which corresponds to the address information 322: “0” of the counter table 321, from “0” to “1”. Then, the converting unit 311 generates the key “(0, 1)” by combining the address information “0” and the counter value “1” based on the updated counter table 321, and generates the KVS request 20A that includes the key “(0, 1)”.

Since the KVS request 20A issued for instructing a writing operation, the storage I/F 312 transmits the KVS request 20A to the master storage device (the first storage device 211) as well as to the slave storage devices (the second storage device 212 and the third storage device 213). Moreover, the storage I/F 312 writes the KVS request 20A, which has been transmitted to the master storage device, in the request monitoring table 341.

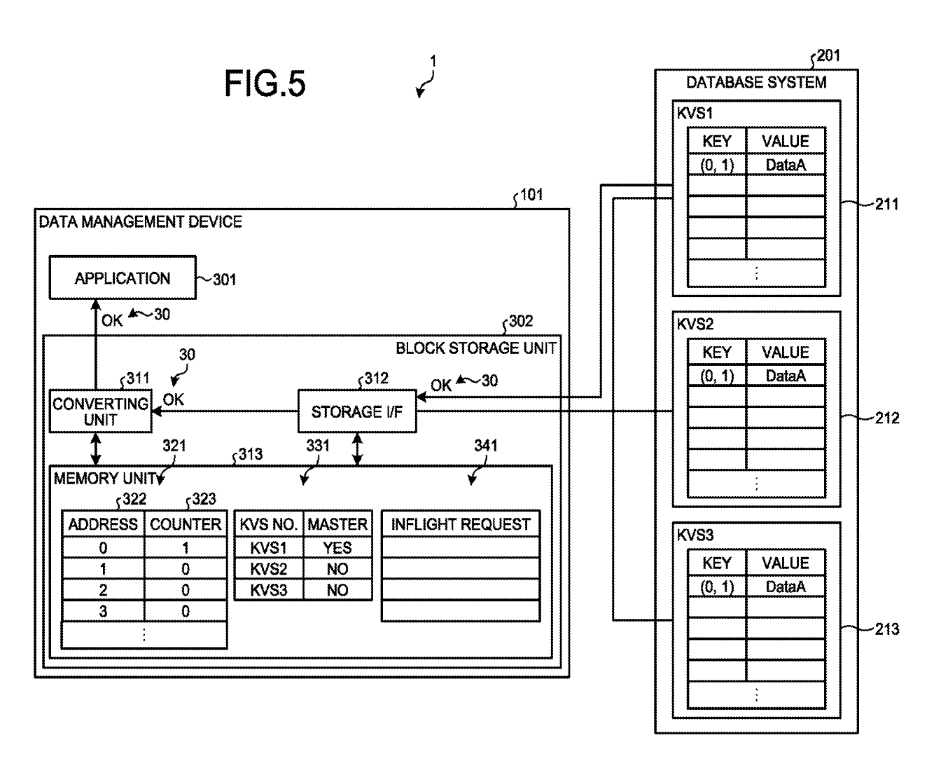

FIG. 5 is a diagram illustrating the state in the case in which a writing instruction is implemented in the data management system 1 according to the first embodiment. The storage devices 211 to 213 that have received the KVS request 20A store data made of the key “(0, 1)” and the value “DataA”. When the writing operation is performed normally, the first storage device 211 representing the master storage device transmits a response signal 30, which indicates that the writing operation has been performed normally, to the data management device 101 (the storage I/F 312). Upon receiving the response signal 30, the storage I/F 312 deletes the KVS request 20A corresponding to the response signal 30 from the request monitoring table 341.

The response signal 30 that is received by the storage I/F 312 is transmitted to the application 301 via the converting unit 311. Thus, via the application 301, the user can recognize that the writing instruction was implemented normally.

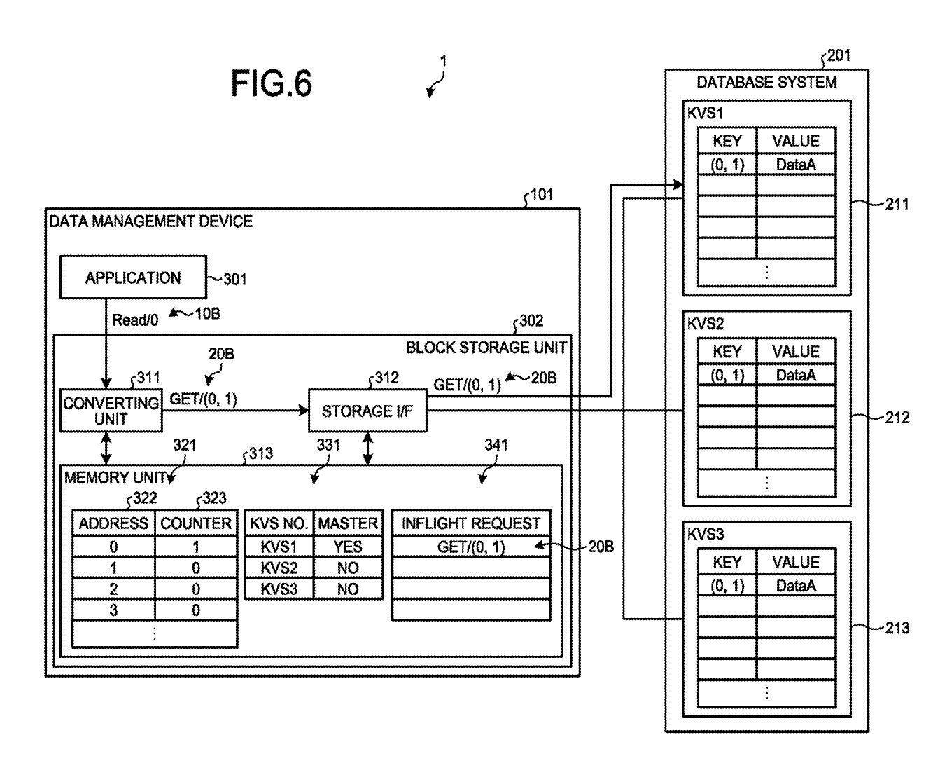

FIG. 6 is a diagram illustrating the state in the case in which a reading instruction is issued in the data management system 1 according to the first embodiment. In this example, it is illustrated that the application 301 receives from the user an instruction for reading the data stored at the address information “0”. The application 301 generates a user request 10B that includes the character string “Read” indicating a reading instruction and includes the address information “0”.

The converting unit 311 converts the user request 10B into a KVS request 20B. Herein, the KVS request 20B includes the command “GET” indicating a writing instruction and includes the key “(0, 1)”.

Since “Write” is not included in the user request 10B, the converting unit 311 does not update the counter table 321. The converting unit 311 obtains the counter value 323: “1” corresponding to the address information 2: “0” in the counter table 321, and generates the key “(0, 1)” by combining the address information “0” and the counter value “1”. Then, the converting unit 311 generates the KVS request 20B that includes the key “(0, 1)”.

Since the KVS request 20B is issued for performing a reading operation, the storage I/F 312 transmits the KVS request 20D only to the master storage device (the first storage device 211). Moreover, the storage I/F 312 writes the KVS request 20B, which has been transmitted to the master storage device, in the request monitoring table 341.

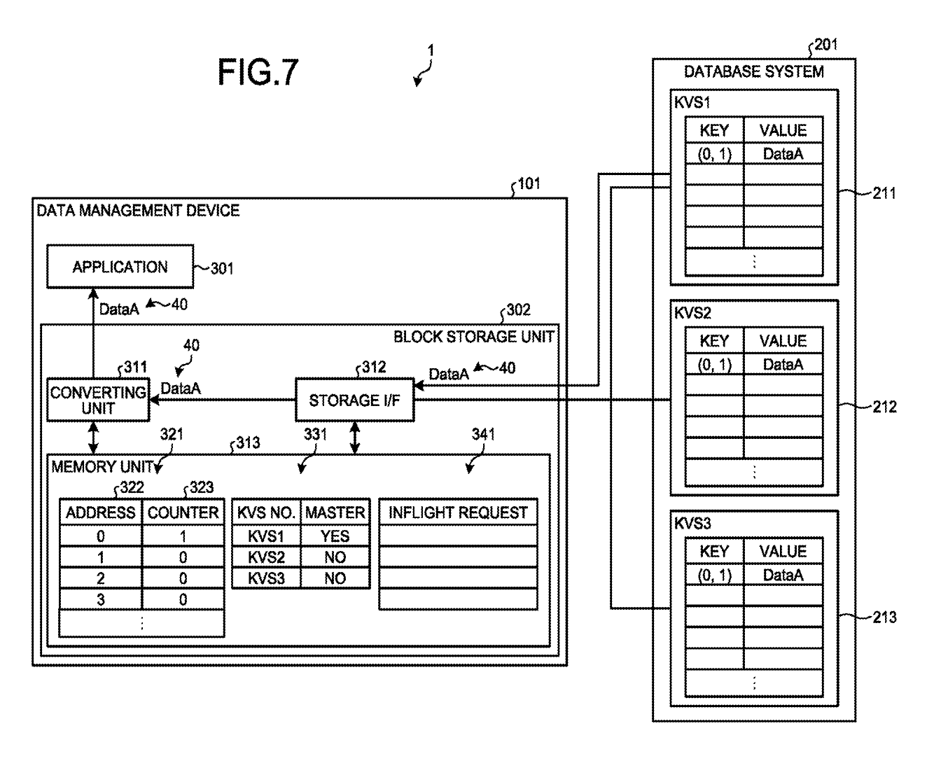

FIG. 7 is a diagram illustrating the state in the case in which a reading instruction is implemented in the data management system 1 according to the first embodiment. The storage device 211 that receives the KVS request 20B reads a value 40 “DataA” corresponding to the key “(0, 1)” and transmits it to the storage I/F 312. Upon receiving the value 40 “DataA”, the storage I/F 312 deletes the KVS request 20B from the request monitoring table 341.

The value 40 “DataA” that is transmitted to the storage I/F 312 is also transmitted to the application 301 via the converting unit 311. Thus, via the application 301, the user can obtain the value 40 “DataA”.

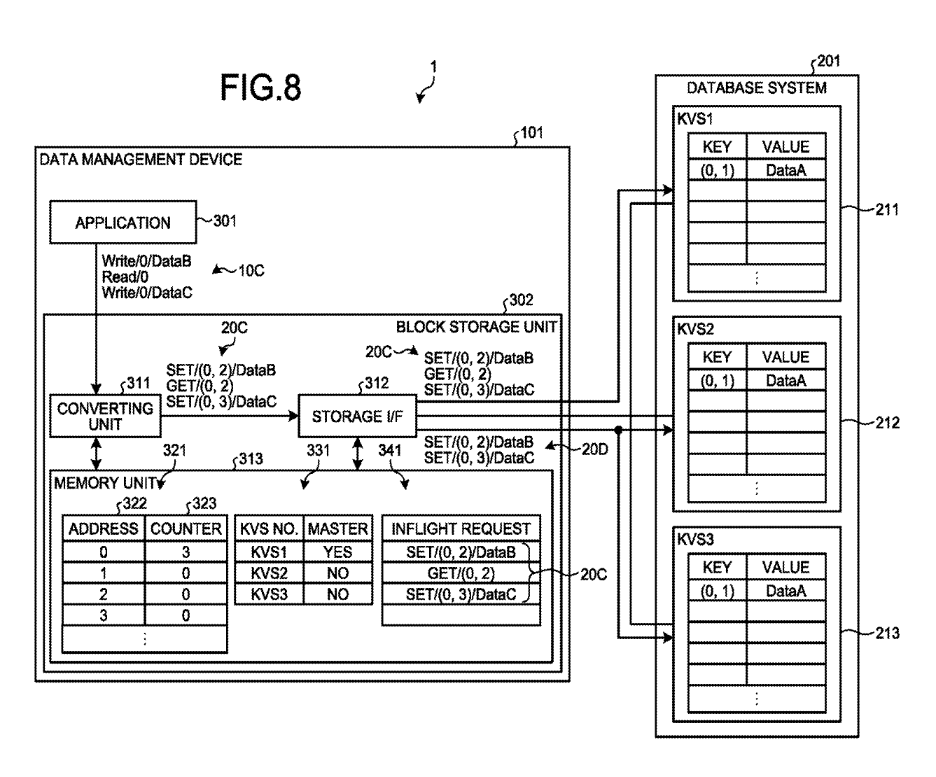

FIG. 8 is a diagram illustrating the state in the case in which a writing instruction and a reading instruction are issued in the data management system 1 according to the first embodiment. In this example, it is illustrated that the application 301 receives from the user the following instructions in that order: a writing instruction for writing a value “DataB” in the area indicated by the address information “0”; a reading instruction for reading the data stored at the address information “0”; and a writing instruction for writing a value “DataC” in the area indicated by the address information “0”. That is, two writing instructions are issued with respect to the address information “0” at different timings, and a reading instruction is issued in between the two writing instructions. Then, the application 301 transmits user requests 10C “Write/0/DataB”, “Read/0”, and “Write/0/DataC” corresponding to the issued instructions to the converting unit 311.

The converting unit 311 converts the user requests 10C into KVS requests 20C “SET/(0, 2)/DataB”, “GET/(0, 2)”, and “SET/(0, 3)/DataC”.

Firstly, according to the fact that “Write” is included in the initial user request 10C “Write/0/DataB”, the converting unit 311 updates the counter table 321, and increments the counter value 323: “1” corresponding to the address information 322: “0” (i.e., the state illustrated in FIGS. 7) to “2”. Then, the converting unit 311 generates a key “(0, 2)” by combining the address information “0” and the counter value “2” based on the updated counter table 321, and generates the KVS request 20C “SET/(0, 2)/DataB” corresponding to the user request 10C “WRITE/0/DataB”.

Subsequently, the converting unit 311 generates the KVS request 20C “GET/(0, 2)” corresponding to the second user request 10C “Read/0”. At that time, since “Write” is not included in the user request 10C “Read/0”, the converting unit 311 does not update the counter table 321. Then, the converting unit 311 generates the key “(0, 2)” by combining the address information “0” and the counter value “2” based on the current counter table 321, and generates the KVS request 20C “GET/(0, 2)”.

Subsequently, the converting unit 311 generates the KVS request 20C “SET/(0, 3)/DataC” corresponding to the third user request 10C “Write/0/DataC”. At that time, according to the fact that “Write” is included in the third user request 10C “Write/0/DataC”, the converting unit 311 updates the counter table 321 and increments the counter value 323 corresponding to the address information 322: “0” from “2” to “3”. Then, the converting unit 311 generates a key “(0, 3)” by combining the address information “0” and the counter value “3” based on the updated counter table 321, and generates the KVS request 20C “SET/(0, 3)/DataC” corresponding to the user request 10C “Write/0/DataC”.

The storage I/F 312 transmits all KVS requests 20C “SET/(0, 2)/DataB”, “GET/(0, 2)”, and “SET/(0, 3)/DataC” to the first storage device 211 representing the master storage device. Moreover, the storage I/F 312 transmits the KVS requests 20D “SET/(0, 2)/DataB” and “SET/(0, 3)/DataC”, which are requests for a writing operation, to the second storage device 212 and the third storage device 213 representing the slave storage devices. Furthermore, the storage I/F 312 writes, in the request monitoring table 341, the KVS requests 20C “SET/(0, 2)/DataB”, “GET/(0, 2)”, and “SET/(0, 3)/DataC” that have been transmitted to the master storage device.

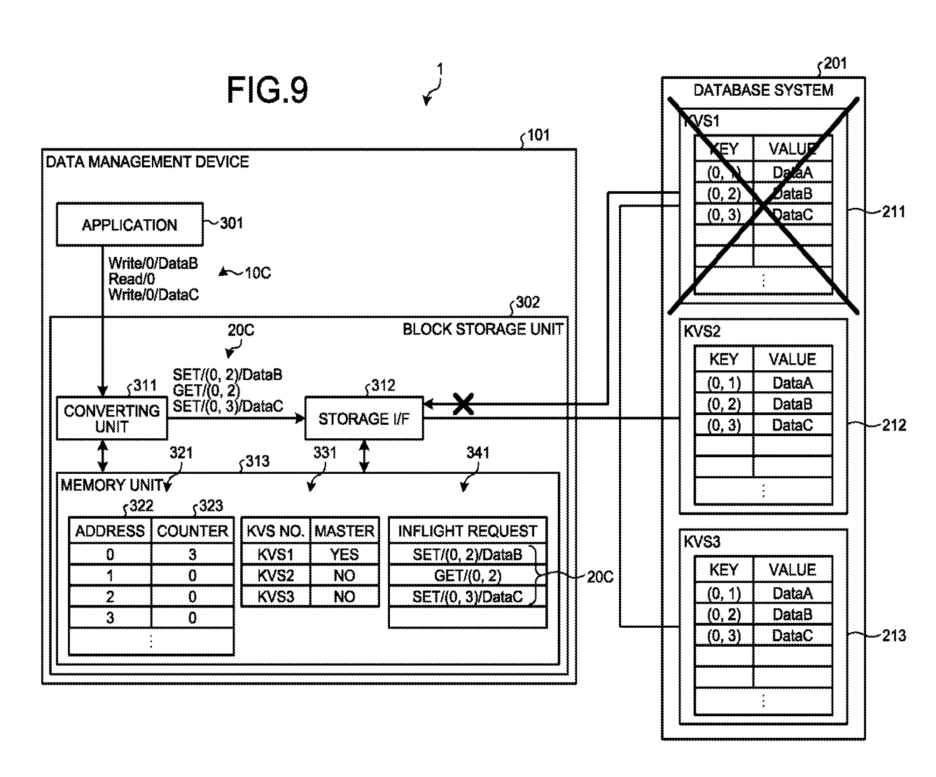

FIG. 9 is a diagram illustrating the state in the case in which a failure occurs in the master storage device of the data management system 1 according to the first embodiment. In this example, it is illustrated that there is no response from the first storage device 211, which represents the master storage device, after the KVS requests 20C “SET/(0, 2)/DataB”, “GET/(0, 2)”, and “SET/(0, 3)/DataC” illustrated in FIG. 8 have been transmitted thereto. in FIG. 9, the state is illustrated in which data “(0, 2) DataB” and “(0, 3) DataC” corresponding to the KVS requests 20C “SET/(0, 2)/DataB” and “SET/(0, 3)/DataC”, respectively, is stored in all storage devices 211 to 213, and in which the KVS requests 20C “SET/(0, 2)/DataB”, “GET/(0, 2)”, and “SET/(0, 3)/DataC” are still listed in the request monitoring table 341. That happens because there is no response from the master storage device in spite of the implementation of the writing operations, and hence the storage I/F 312 cannot delete the KVS requests from the request monitoring table 341.

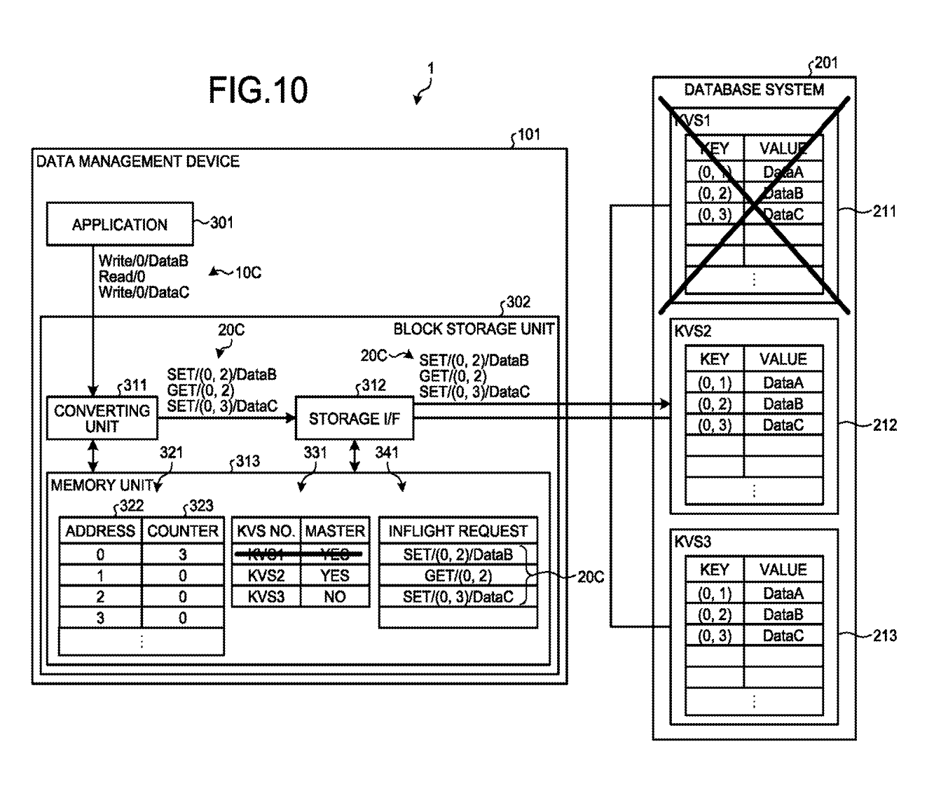

FIG. 10 is a diagram illustrating the state in the case in which the KVS requests 20C are retransmitted in the data management system 1 according to the first embodiment. In this example, after the state illustrated in FIG. 9 is attained, the master storage device is changed from the first storage device 211 to the second storage device 212.

The storage I/F 312 updates the master monitoring table 331 in response to the change in the master storage device. Then, the storage I/F 312 retransmits the KVS requests 20C, which are still listed in the request monitoring table 341, to the second storage device 212 representing the new master storage device.

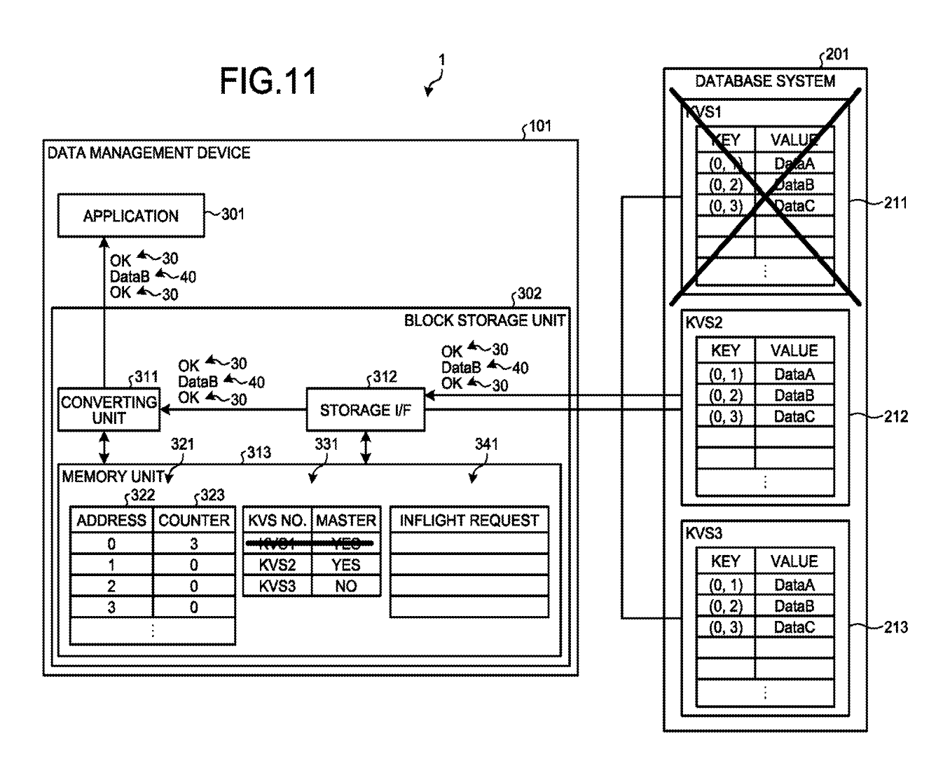

FIG. 11 is a diagram illustrating the state in the case in which the instructions corresponding to the retransmitted KVS requests 20C are implemented in the data management system 1 according to the first embodiment. In FIG. 11, the state is illustrated in which a response to each KVS request 20C is sent to the storage I/F 312 from the second storage device 212 representing the new master storage device. The uppermost response signal 30 “OK” illustrated in FIG. 11 represents the response with respect to the KVS request 20C “SET/(0, 2)/DataB”. The value 40 “DataB” represents the response with respect to the KVS request 20C “GET/(0, 2)”. The lowermost response signal 30 “OK” illustrated in FIG. 11 represents the response to the KVS request 20C “SET/(0, 3)/DataC”. These responses are sent to the application 301 via the converting unit 311, and are confirmed by the user. Thus, in response to the reception of the responses, the storage I/F 312 deletes the KVS requests 20C from the request monitoring table 341.

As described above, according to the first embodiment, regarding the retransmitted KVS request 20C “GET/(0, 2)” for a reading operation, the value 40 “DataB” represents the response. The result of that response matches with the result of the response that would have been obtained in the pre-failure master storage device (the first storage device 211 representing the master storage device). That is because the KVS request 20C “GET/(0, 2)” issued before the failure (see FIG. 8) is identical to the retransmitted KVS request 20C “GET/(0, 2)” (see FIG. 10).

In the examples illustrated in FIGS. 8 to 10, as the initial instruction, the user issues an instruction for writing the value “DataB” at the address information “0”. Then, as the second instruction, the user issues an instruction for reading the value corresponding to the address information. Subsequently, as the third instruction, the user issues an instruction for writing the value “DataC” at the address information “0”. Thus, in response to the reading instruction issued second, it becomes necessary that the value “DataB” that is written in response to the initial writing instruction is read. However, in a conventional system, after a KVS request corresponding to the third writing instruction (i.e., the writing request for writing “DataC”) is transmitted, if a KVS request corresponding to the second reading instruction is to be retransmitted in response to a change in the master storage device, then the value “DataC” that is written at later instance may be obtained instead of the value “DataB” that should be obtained.

In contrast, in the first embodiment, the key of the KVS request 20 includes the version information that is updated every time a writing instruction is issued. Hence, even if the KVS request 20 is retransmitted, the writing operation can be appropriately performed without getting affected by the writing operation performed at a later instance. Moreover, since a plurality of writing operations or reading operations can be performed in a concurrent manner, there is no decline in the throughput. Thus, according to the first embodiment, in a KVS-type database, the reliability can be enhanced without causing a decline in the throughput.

### Second Embodiment

A second embodiment is described below reference to the accompanying drawings. The identical constituent elements to those explained in the first embodiment are referred to by the same reference numerals, and the explanation is sometimes not repeated.

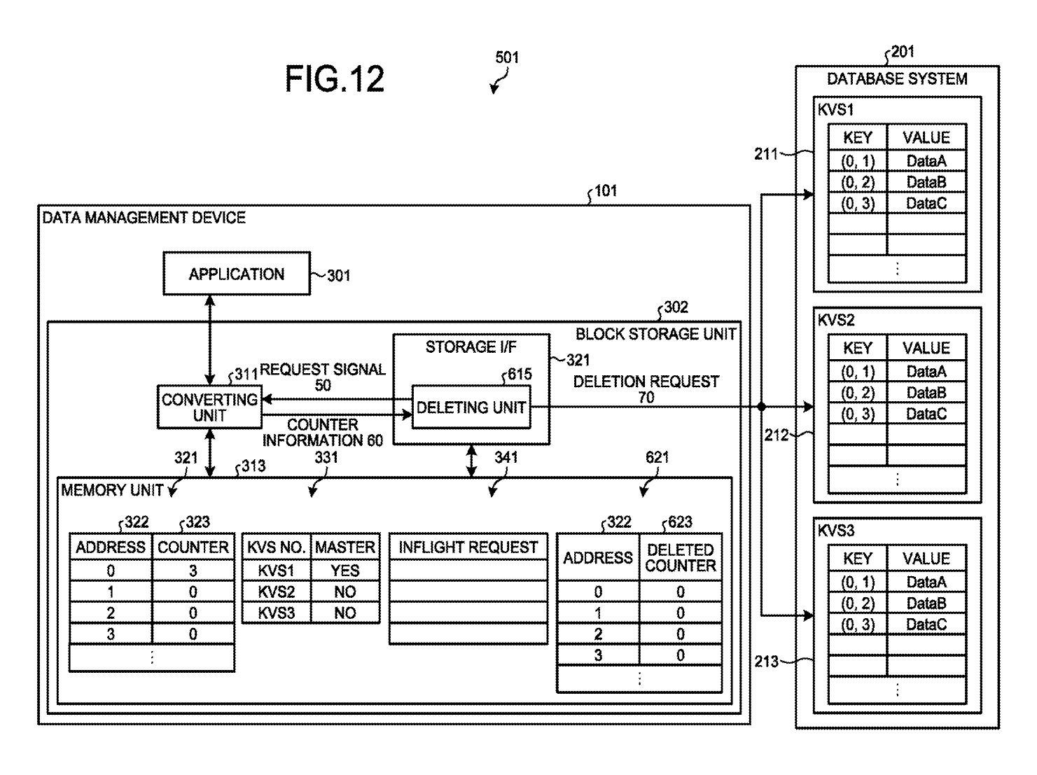

FIG. 12 is a diagram illustrating a functional configuration of a data management system 501 according to the second embodiment. In the second embodiment, the storage I/F 312 includes a deleting unit 615; and the memory unit 313 is used to store a data deletion monitoring table 621.

The deleting unit 615 performs operations for deleting the data corresponding to the past sets of version information from the data stored in the storage devices 211 to 213. The deleting unit 615 transmits a request signal 50 to the converting unit 311 at predetermined timings (for example, at regular intervals). The request signal 50 is a signal for requesting the converting unit 311 to transmit the current counter value 323 corresponding to each set of address information 322. Upon receiving the request signal 50, the converting unit 311 generates counter information 60 that contains the correspondence relationship between the sets of address information 322 and the current counter values 323 based on the counter table 321, and transmits counter information 60 to the deleting unit 615. Upon receiving the counter information 60, the deleting unit 615 issues, to the database system 201, a deletion request 70 for instructing an operation of deleting the data containing the keys having the past version information (counter values). The deleting unit 615 updates the data deletion monitoring table 621 according to the data deletion. Herein, the data deletion monitoring table 621 is a table indicating the correspondence relationship between the sets of address information 322 and deletion counter values 623 indicating the version information of the deleted sets of data.

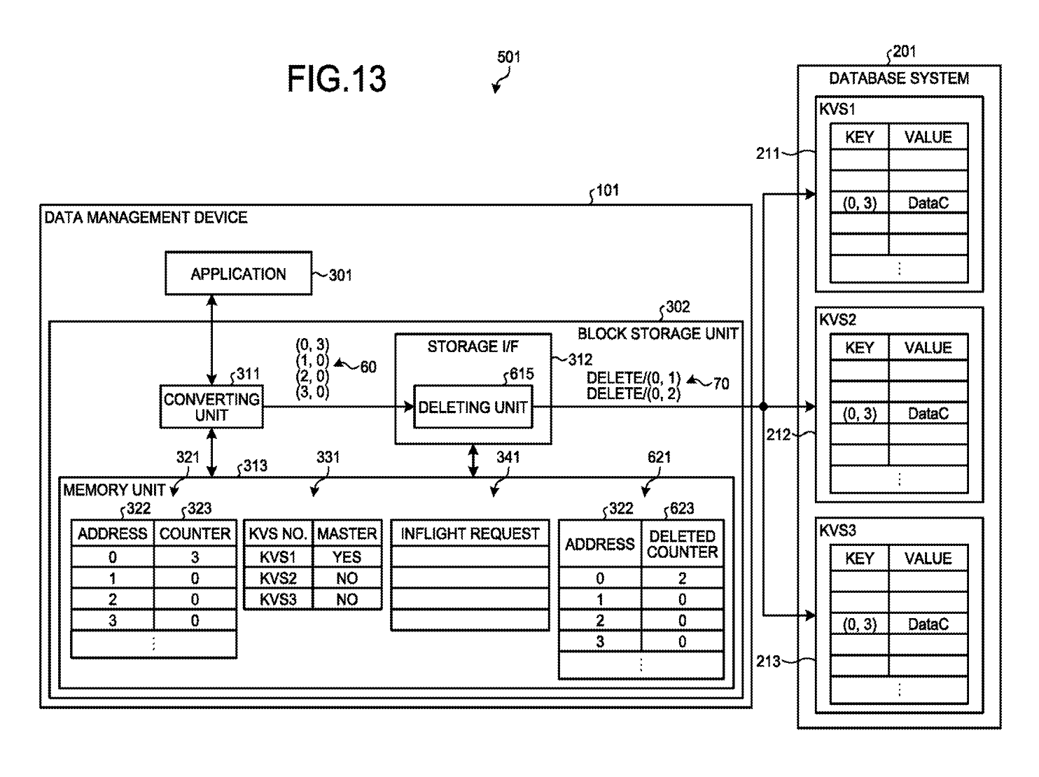

FIG. 13 is a diagram illustrating the state in the case in which the data corresponding to the past sets of version information is deleted in the data management system 501 according to the second embodiment. In this example, the state after the reception of the request signal 50 by the converting unit 311 is illustrated. In response to the reception of the request signal 50, the converting unit 311 transmits the counter information 60 “(0, 3), (1, 0), (2, 0), and (3, 0)” to the deleting unit 615. Herein, the counter information 60 corresponds to the contents of the counter table 321.

Based on the counter information 60, the deleting unit 615 generates deletion requests 70 “DELETE/(0, 1)” and “DELETE/(0, 2)”, and transmits them to the database system 201. The deletion request 70 “DELETE/(0, 1)” is a KVS command for deleting the data containing the key (0, 1); while the deletion request 70 “DELETE/(0, 2)” is a KVS command for deleting the data containing the key (0, 2). In this example, if A represents the already-deleted deletion counter value 623 and if B represents the current counter value 323, then the deleting unit 615 deletes the data corresponding to the counter values from A to (B−1). In this example, the already-deleted deletion counter value 623 (A) corresponding to the address information 322: “0” is “0” (see FIG. 12), and the current counter value 323 (B) corresponding to the address information 322: “0” is “3”. Hence, data “(0, 1) DataA” and data “(0, 2) DataB” containing the key having the address information “0” and one of the counter values “0” to “2” represents the data that has been deleted. According to the deletion of the data, the storage I/F 312 updates the deletion counter value 623 of the data deletion monitoring table 621.

As described above, according to the second embodiment, in addition to achieving the effect according to the first embodiment, the data corresponding to the pass versions can be deleted from the storage devices 211 to 213. That makes it possible to hold down the loss of the memory capacity of the storage devices 211 to 213.

Meanwhile, the computer programs for implementing the various functions of the data management systems 1 and 501 (the data management device 101) can be recorded as installable or executable files in a computer-readable recording medium such as a compact disk read only memory (CD-ROM), a flexible disk (FD), a compact disk recordable (CD-R), and a digital versatile disk (DVD). Alternatively, the computer programs can be downloaded from a predetermined memory device connected to a network into a predetermined information processing device. Still alternatively, the computer programs can be stored in advance in a ROM of a predetermined information processing device. Herein, the computer programs can be made of a plurality of modules for implementing the various functions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data management device comprising circuitry configured to:
obtain a first-type request which includes address information corresponding to a writing instruction or a reading instruction with respect to a value;
convert the first-type request into a second-type request which includes a key having a combination of the address information and version information, the version information being updated every time the writing instruction is issued with position indicated by the address information as writing position; and
perform, based on the second-type request,
either a writing operation for writing the value corresponding to the key in a key value store type database including a plurality of storage devices each of which is set either as a master storage device or as slave storage device,
or a reading operation for reading value corresponding to the key from the database.

2. The data management device according to claim 1, wherein the circuitry is further configured to:
send the second-type request for performing the writing operation to the master storage device and the slave storage device, and
send the second-type request for performing the reading operation only to the master storage device.

3. The data management device according to claim 2, wherein the circuitry is further configured to:
determine, based on a response from the master storage device with respect to the second-type request, the second-type request that is unimplemented, and
when the master storage device is changed, retransmit the second-type request that is unimplemented to the master storage device that is newly set.

4. The data management device according to claim 3, wherein the circuitry is further configured to:
hold the second-type request that has been transmitted to the master storage device, and
based on information about deletion of the second-type request for which a normal response is received from the master storage device, determine the second-type request that is unimplemented.

5. The data management device according to claim 1, wherein the circuitry is further configured to:
delete, from the database, data corresponding to the key having the version information of past.

6. A data management method comprising:
obtaining a first-type request which includes address information corresponding to a writing instruction or a reading instruction with respect to a value;
converting the first-type request into a second-type request which includes a key having a combination of the address information and version information, the version information being updated every time the writing instruction is issued with position indicated by the address information as writing position; and
performing, based on the second-type request,
either a writing operation for writing the value corresponding to the key in a key value store type database including a plurality of storage devices each of which is set either as a master storage device or as a slave storage device,
or a reading operation for reading the value corresponding to the key from the database.

7. The data management method according to claim 6, further comprising:
sending the second-type request for performing the writing operation to the master storage device and the slave storage device, and
sending the second-type request for performing the reading operation only to the master storage device.

8. The data management method according to claim 7, further comprising:
determining, based on a response from the master storage device with respect to the second-type request, the second-type request that is unimplemented, and
when the master storage device is changed, retransmitting the second-type request that is unimplemented to the master storage device that is newly set.

9. The data management method according to claim 8, further comprising:
holding the second-type request that has been transmitted to the master storage device, and
based on information about deletion of the second-type request for which a normal response is received from the master storage device, determining second-type request that is unimplemented.

10. The data management method according to claim 6, further comprising:
deleting, from the database, data corresponding to the key having the version information of past.

11. A computer program product having a non-transitory computer readable medium including a data management program, wherein the data management program, when executed by a computer, causes the computer to execute:
obtaining a first-type request which includes address information corresponding to a writing instruction or a reading instruction with respect to a value;
converting the first-type request into a second-type request which includes a key having a combination of the address information and version information, the version information being updated every time the writing instruction is issued with position indicated by the address information as writing position; and
performing, based on the second-type request,
either a writing operation for writing the value corresponding to the key in a key value store type database including a plurality of storage devices each of which is set either as a master storage device or as a slave storage device,
or a reading operation for reading the value corresponding to the key from the database.

12. The computer program product according to claim 11, wherein the data management program causes the computer further to execute:
sending the second-type request for performing the writing operation to the master storage device and the slave storage device, and
sending the second-type request for performing the reading operation only to the master storage device.

13. The computer program product according to claim 12, wherein the data management program causes the computer further to execute:
determining, based on a response from the master storage device with respect to the second-type request, the second-type request that is unimplemented, and
when the master storage device is changed, retransmitting the second-type request that is unimplemented to the master storage device that is newly set.

14. The computer program product according to claim 13, wherein the data management program causes the computer further to execute:
holding the second-type request that has been transmitted to the master storage device, and
based on information about deletion of the second-type request for which a normal response is received from the master storage device, determining the second-type request that is unimplemented.

15. The computer program product according to claim 11, wherein the data management program causes the computer further to execute:
deleting, from the database, data corresponding to the key having the version information of past.
